(19) United States
(12) Patent Application Publication
(10) Pub. No.: US 2020/0210186 A1
(43) Pub. Date: Jul. 2, 2020

(54) APPARATUS AND METHOD FOR NON-SPATIAL STORE AND SCATTER INSTRUCTIONS

(71) Applicant: Intel Corporation, Santa Clara, CA (US)

(72) Inventor: Elmoustapha OULD-AHMED-VALL, Chandler, AZ (US)

(21) Appl. No.: 16/233,418

(22) Filed: Dec. 27, 2018

(51) Int. Cl. G06F 9/345; G06F 9/30; G06F 9/38; G06F 12/0811

(52) U.S. Cl. CPC G06F 9/3455; G06F 9/30043; G06F 9/544; G06F 12/0811; G06F 9/3816

(57) ABSTRACT

Embodiments of systems, apparatuses, and methods for storing data elements in a processor are described. For example, execution circuitry executes a decoded instruction, the instruction having a first field identifying a location in main memory, a second field identifying a register storing a data element to be stored at the location in main memory, and an opcode to indicate to execution circuitry to store the data element at the location in main memory without storing the data element in a data cache of the processor, by storing the data element at the location in main memory without storing the data element in the data cache of the processor.

### FIELD

This disclosure relates to microprocessors and, more particularly, to storing data elements by microprocessors.

### BACKGROUND

The stride of an array (also referred to as increment, pitch, or step size) refers to the number of locations in memory between beginnings of successive array elements. Many scientific applications have arrays with large strides. These occur naturally, for example, when:
Accessing matrices (or 2D/3D arrays). If the elements of the same column are accessed sequentially, such as A[0][3], A[1][3], A[2][3] . . . ;
Accessing the same number of structures organized as Array of Structures (AoS) such as A[0]·weight, A[1]·weight, A[2]·weight. . . .

Such strided access and storage patterns are common in high performance computing (HPC) and scientific computing applications due to the nature of the algorithms used. Many of these strided accesses and stores have large stride values, usually greater than the length of a cache line (e.g., 64 bytes). Such accesses and stores do not exhibit spatial locality. That is, if a data element X is accessed or stored, then the data elements that are close to data element X are no more likely to be accessed or stored than the data elements far away from data element X.

### BRIEF DESCRIPTION OF THE DRAWINGS

The present invention is illustrated by way of example, and not by way of limitation, in the figures of the accompanying drawings in which like references indicate similar elements.

FIG. 1A illustrates a system architecture of a processor according to some embodiments.

FIG. 1B illustrates a comparison of a spatial store operation that uses a data cache when storing data elements with a non-spatial store operation that stores data elements directly to main memory and without using a data cache according to some embodiments.

FIGS. 2 is a flow diagram illustrating an example method of storing data elements directly to main memory and without using a data cache according to some embodiments.

FIGS. 3A-3C illustrate an exemplary instruction format.

FIG. 4 is a block diagram of a register architecture according to one embodiment of the invention;

FIGS. 5A-5B illustrate the in-order pipeline and in-order core;

FIGS. 6A-7B illustrate a block diagram of a more specific exemplary in-order core architecture, which core would be one of several logic blocks (including other cores of the same type and/or different types) in a chip;

FIG. 7 is a block diagram of a processor that may have more than one core, may have an integrated memory controller, and may have integrated graphics according to embodiments of the invention;

FIGS. 8-11 are block diagrams of exemplary computer architectures; and

FIG. 12 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

In one embodiment of the invention, an apparatus for storing data elements in a computer system is disclosed. The processor contains an L1 cache and at least one processor core coupled to the L1 cache. The processor core further includes one or more registers and a plurality of instruction processing stages including a decoder unit and an execution unit. The decoder unit is configured to decode an instruction having a first field identifying a location in main memory, a second field identifying a register storing a data element to be stored at the location in main memory, and an opcode to indicate to execution circuitry to store the data element at the location in main memory without storing the data element in a data cache of the processor. The execution unit is configured to store the data element at the location in main memory without storing the data element in the data cache of the processor.

In one embodiment of the invention, a method for storing data elements in a computer system is disclosed. The method includes decoding an instruction having a first field identifying a location in main memory, a second field identifying a register storing a data element to be stored at the location in main memory, and an opcode to indicate to execution circuitry to store the data element at the location in main memory without storing the data element in a data cache of the processor. The method also includes, after decoding the instruction, executing the decoded instruction by an execution circuit by storing the data element at the location in main memory without storing the data element in the data cache of the processor.

In one embodiment, a computer system is disclosed. The computer system contains a memory for storing instructions, a processor including a data cache and at least one processor core for processing the instructions. The processor core is coupled to the data cache and it includes one or more registers and a plurality of instruction processing stages including a decoder unit and an execution unit. The decoder unit is configured to decode an instruction having a first field identifying a location in main memory, a second field identifying a register storing a data element to be stored at the location in main memory, and an opcode to indicate to execution circuitry to store the data element at the location in main memory without storing the data element in a data cache of the processor. The execution unit is configured to execute the decoded instruction by an execution circuit by storing the data element at the location in main memory without storing the data element in the data cache of the processor.

### Instruction Set

An instruction set, or instruction set architecture (ISA), is the part of the computer architecture related to programming, and may include the native data types, instructions, register architecture, addressing modes, memory architecture, interrupt and exception handling, and external input and output (I/O). The term instruction generally refers herein to macro-instructions—that is instructions that are provided to the processor (or instruction converter that translates (e.g., using static binary translation, dynamic binary translation including dynamic compilation), morphs, emulates, or otherwise converts an instruction to one or more other instructions to be processed by the processor) for execution—as opposed to micro-instructions or micro-operations (micro-ops)—that is the result of a processor's decoder decoding macro-instructions.

The ISA is distinguished from the microarchitecture, which is the internal design of the processor implementing the instruction set. Processors with different microarchitectures can share a common instruction set. For example, Intel® Pentium 4 processors, Intel® Core™ processors, and processors from Advanced Micro Devices, Inc. of Sunnyvale, Calif. implement nearly identical versions of the x86 instruction set (with some extensions that have been added with newer versions), but have different internal designs. For example, the same register architecture of the ISA may be implemented in different ways in different microarchitectures using well-known techniques, including dedicated physical registers, one or more dynamically allocated physical registers using a register renaming mechanism (e.g., the use of a Register Alias Table (RAT), a Reorder Buffer (ROB), and a retirement register file; the use of multiple maps and a pool of registers), etc. Unless otherwise specified, the phrases register architecture, register file, and register are used herein to refer to that which is visible to the software/programmer and the manner in which instructions specify registers. Where a specificity is desired, the adjective logical, architectural, or software visible will be used to indicate registers/files in the register architecture, while different adjectives will be used to designation registers in a given microarchitecture (e.g., physical register, reorder buffer, retirement register, register pool).

An instruction set includes one or more instruction formats. A given instruction format defines various fields (number of bits, location of bits) to specify, among other things, the operation to be performed (opcode) and the operand(s) on which that operation is to be performed. Some instruction formats are further broken down through the definition of instruction templates (or subformats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) often require the same operation to be performed on a large number of data items (referred to as “data parallelism”). Single Instruction Multiple Data (SIMD) refers to a type of instruction that causes a processor to perform an operation on multiple data items. SIMD technology is especially suited to processors that can logically divide the bits in a register into a number of fixed-sized data elements, each of which represents a separate value. For example, the bits in a 256-bit register may be specified as a source operand to be operated on as four separate 64-bit packed data elements (quad-word (Q) size data elements), eight separate 32-bit packed data elements (double word (D) size data elements), sixteen separate 16-bit packed data elements (word (W) size data elements), or thirty-two separate 8-bit data elements (byte (B) size data elements). This type of data is referred to as packed data type or vector data type, and operands of this data type are referred to as packed data operands or vector operands. In other words, a packed data item or vector refers to a sequence of packed data elements, and a packed data operand or a vector operand is a source or destination operand of a SIMD instruction (also known as a packed data instruction or a vector instruction).

By way of example, one type of SIMD instruction specifies a single vector operation to be performed on two source vector operands in a vertical fashion to generate a destination vector operand (also referred to as a result vector operand) of the same size, with the same number of data elements, and in the same data element order. The data elements in the source vector operands are referred to as source data elements, while the data elements in the destination vector operand are referred to a destination or result data elements. These source vector operands are of the same size and contain data elements of the same width, and thus they contain the same number of data elements. The source data elements in the same bit positions in the two source vector operands form pairs of data elements (also referred to as corresponding data elements; that is, the data element in data element position 0 of each source operand correspond, the data element in data element position 1 of each source operand correspond, and so on). The operation specified by that SIMD instruction is performed separately on each of these pairs of source data elements to generate a matching number of result data elements, and thus each pair of source data elements has a corresponding result data element. Since the operation is vertical and since the result vector operand is the same size, has the same number of data elements, and the result data elements are stored in the same data element order as the source vector operands, the result data elements are in the same bit positions of the result vector operand as their corresponding pair of source data elements in the source vector operands. In addition to this exemplary type of SIMD instruction, there are a variety of other types of SIMD instructions (e.g., that have only one or have more than two source vector operands, that operate in a horizontal fashion, that generate a result vector operand that is of a different size, that have different size data elements, and/or that have different data element orders). It should be understood that the term destination vector operand (or destination operand) is defined as the direct result of performing the operation specified by an instruction, including the storage of that destination operand at a location (be it a register or at a memory address specified by that instruction) so that it may be accessed as a source operand by another instruction (by specification of that same location by the another instruction).

The SIMD technology, such as that employed by the Intel® Core™ processors having an instruction set including x86, MMX™, Streaming SIMD Extensions (SSE), SSE2, SSE3, SSE4.1, and SSE4.2 instructions, has enabled a significant improvement in application performance. An additional set of SIMD extensions, referred to the Advanced Vector Extensions (AVX) (AVX1 and AVX2) and using the Vector Extensions (VEX) coding scheme has been released and/or published (e.g., see Intel® 64 and IA-32 Architectures Software Developers Manual, October 2011; and see Intel® Advanced Vector Extensions Programming Reference, June 2011).

### System Architecture

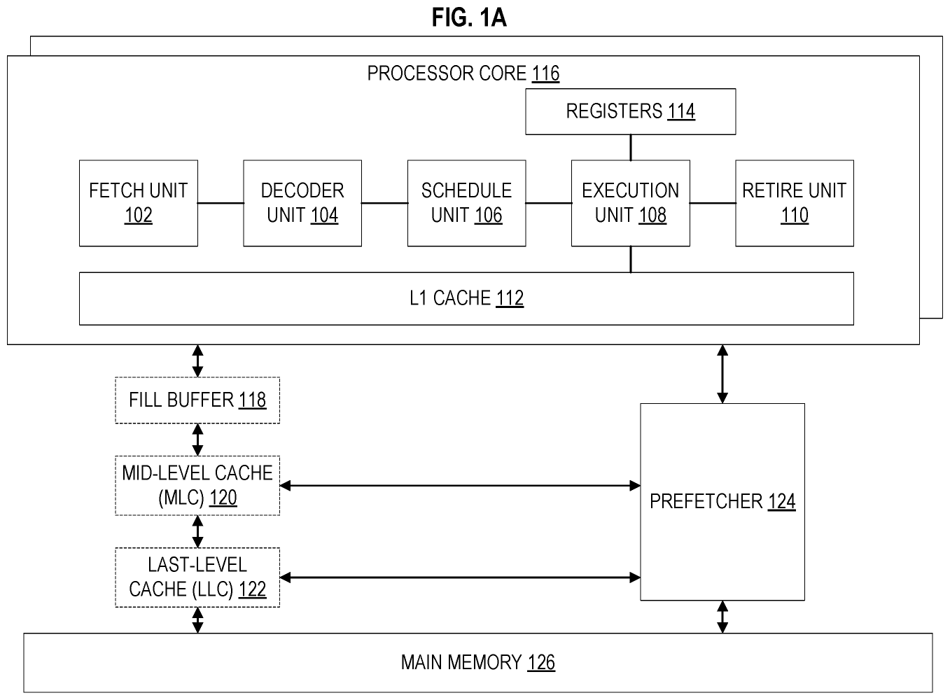

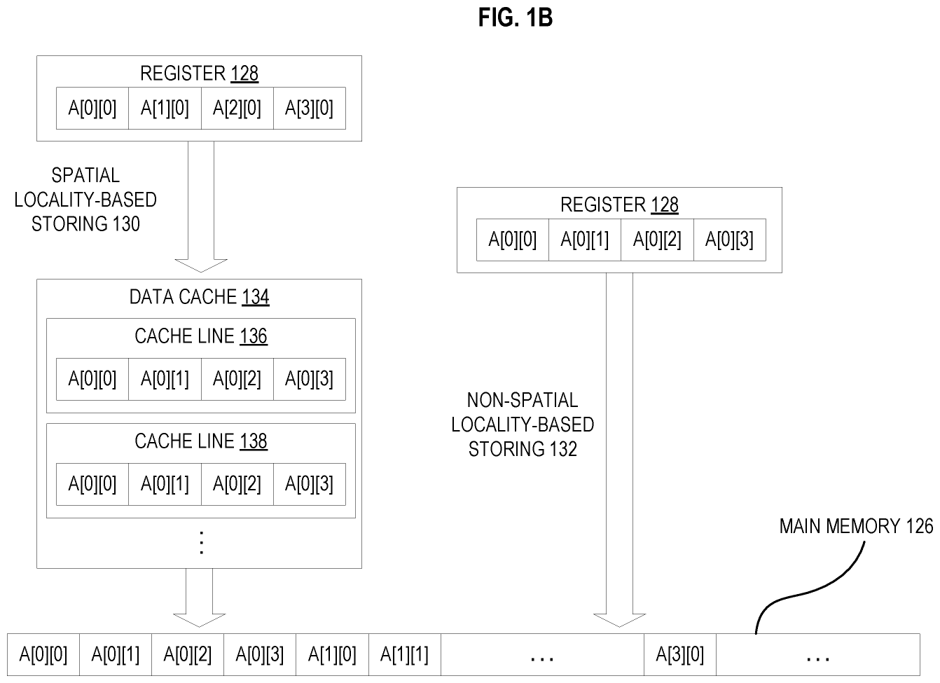

FIG. 1A illustrates a system architecture of a processor according to one embodiment of the invention. The processor 100 contains one or more processor cores such as a processor core 150, a prefetcher 130, and a main memory 140. It may optionally include a lower level cache (LLC) 124, a mid-level cache (MLC) 122, and/or a fill buffer 120 in one embodiment. The processor is a part of a computing system in one embodiment.

Processor core 150 may be implemented on a single integrated circuit chip (or die). Moreover, the chip may include one or more shared and/or private caches (LLC 124 or MLC 122), interconnections, memory controllers, or other components.

Processor core 150 may include a fetch unit 102 to fetch instructions for execution by the processor core. The instructions may be fetched from any storage devices such as main memory 140 and/or memory devices. Processor core 150 may optionally include a decode unit 104 to decode the fetched instructions. In an embodiment, the decode unit 104 may decode the fetched instruction into a plurality of uops (micro-operations). Some embodiments of the processor core 150 may not include decode unit 104. Hence, the core 150 may process instructions without decoding them. Additionally, the core 150 may include a schedule unit 106. The schedule unit 106 may perform various operations associated with storing decoded instructions (e.g., received from the decode unit 104) until the instructions are ready for dispatch, e.g., until all source values of a decoded instruction become available. In one embodiment, the schedule unit 106 may schedule and/or issue (or dispatch) decoded instructions to an execution unit 108 for execution.

The execution unit 108 may execute the dispatched instructions after they are decoded (e.g., by the decode unit 104) and dispatched (e.g., by the schedule unit 106). The execution unit 108 utilizes one or more registers 107 for execution. The registers 107 may store instructions or data elements to be executed for the instructions. In an embodiment, the execution unit 108 may include more than one execution unit, such as one or more memory execution units, one or more integer execution units, one or more floating-point execution units, or other execution units. The execution unit 108 may also perform various arithmetic operations such as addition, subtraction, multiplication, and/or division, and may include one or more arithmetic logic units (ALUs). In an embodiment, a co-processor (not shown) may perform various arithmetic operations in conjunction with the execution unit 108. Further, the execution unit 108 may execute instructions out-of-order. Hence, the processor core 150 may be an out-of-order processor core in one embodiment. Also, each core 150 may be capable of executing multiple threads simultaneously (SMT or Simultaneous Multi-Threading).

The processor core 150 may also include a retirement unit 110. The retirement unit 110 may retire executed instructions (e.g., in order) after they are committed. In an embodiment, retirement of the executed instructions may result in processor state being committed from the execution of the instructions, physical registers used by the instructions being de-allocated, etc.

The processor core 150 may also include an L1 cache 112. The L1 cache 112 is close to or within processor core 150 and it is the highest level cache in the cache hierarchy and it generally stores instructions/data elements for executing instructions in the execution pipeline such as 102-110. The L1 cache 112 is dedicated to processor core 150, even when there are multiple processor cores in processor 100.

MLC 122 and LLC 124 are caches in lower levels of the cache hierarchy and they store instructions/data elements to facilitate instruction executing by processor cores. Fill buffer 120 is a temporary buffer to store and gather data elements for execution in one embodiment.

The processor may also include a prefetcher 130. The prefetcher 130 fetches instructions/data elements from MLC 122, LLC 124, and/or main memory 140 before the instructions/data elements are requested by a processor core such as processor core 150. Prefetcher 130 speeds up execution of the processor cores by shortening the access time of instructions/data.

A cache typically increases in performance the closer it resides to execution units. In addition, the caches closer to execution units of a processor typically are smaller and quicker than larger higher-level caches (e.g., L1 112 is smaller and quicker than MLC 122 and LLC 124). A fundamental principle of caching is that for the data cached, the more likely the data cached is to be reused, the better. Caching is generally performed based on the principle of locality, which says that execution of instructions accesses a relatively small portion of the address space at any instant of time. There are two types of localities: temporal locality and spatial locality. Temporal locality refers to locality in time, which means that if an item is referenced, it will tend to be referenced again soon.

Spatial locality refers to locality in space. That is, if an item is referenced, items whose addresses are close by (i.e., spatially adjacent) tend to be referenced near in time. For arrays with large strides, the stride access patterns often present low spatial locality and thus existing techniques for storing data elements based on spatial locality may not provide optimal performance.

### Storing Data Elements With and Without Considering Spatial Locality

FIG. 1B illustrates a comparison of a spatial store operation that does consider spatial locality of data elements with a non-spatial store operation that does not consider spatial locality of data elements according to embodiments. Assume that for an instruction, the data elements of the first column of a matrix A (i.e., A[0][0], A[1][0], A[2][0], and A[3][0]) are present in a register 128 and are to be stored to storage locations in main memory 126. In addition, assume each data element is 4 bytes long and each cache line is 64 bytes long. The blocks following reference 130 at the left side of the figure illustrate existing store operations, where the store operation is performed using a data cache 134. The blocks following reference 132 at the right side of the figure illustrate a store operation according to embodiments described herein, where execution of the store operation bypasses a data cache 134 (for example, taking into account that there is a lack of spatial locality associated with the data elements of the matrix to be stored).

When a store operation is performed without considering the lack of spatial locality among the data elements of the matrix, the data elements A[0][0]-A[3][0] are loaded in a data cache 134 of the processor. In addition though, a request to store a data element A[0] [0] by the processor core causes loading of A[0] [0] and data elements spatially adjacent to A[0] [0] from main memory 126 to cache line 136 of data cache 134, the spatially adjacent data elements including A[0][1]-A[0][3]. Similarly, the request to store data element A[1][0] causes loading of A[1][0]-A[1][3] to cache line 138 of data cache 134, and the request to store data elements A[2] [0] and A[3] [0] causes loading of A[2] [0]-A[2] [3] and A[3] [0]-A[3] [3] respectively to cache lines of the data cache 134. In addition, for an implementation that second-sector (next-line) prefetching is enabled, four more cache lines of MLC or LLC are loaded (not shown) for the requested storage of the first column of matrix A. That is, to store 4*4=16 bytes, 64 bytes (cache line length)*8 (4 cache lines at L1 and MLC/LLC each)=512 bytes cache space and processing power are used. That is, only 3.125% of data in the cache data are actually used to store the requested data elements.

While the illustration is a simple example, the storing of multiple data elements that do not exhibit spatial locality happens often, particularly when processing arrays where an array has a large stride (e.g., larger than 64 bytes). The waste of storage and computation resources when indiscriminately loading spatially adjacent data elements in cache lines is significant. Thus, embodiments described herein enable a processor to store data elements with consideration of spatial locality, or lack thereof, of the relevant data elements.

At reference 132, the data elements A[0][0]-A[3][0] are stored only in main memory 126. The storage of the data elements does not include loading the previous copies of the data elements, or spatially adjacent data elements, from main memory 126 into a data cache (e.g., the L1 cache or other level of the cache hierarchy) and thus the operation does not use space in a data cache. Optionally, the relevant data elements may be scattered to a fill buffer such as fill buffer 118 or a lower level cache, such as LLC 122. One difference to the approach illustrated by reference 132 is that the scattering to the fill buffer or the LLC applies only to the data elements stored in the register ‘B00, and spatially adjacent data elements are not loaded to the fill buffer or the LLC from main memory 126. The targeted storing of data elements avoids using cache space/computation resources at L1 and/or MLC, and the resources saved at the smaller/quicker caches closer to the execution unit improves the performance of the execution and thus the performance of the processor.

In one embodiment, a processor is able to perform both types of storing as referred to in references 130 and 132. The different loading operations are performed based on the instruction types.

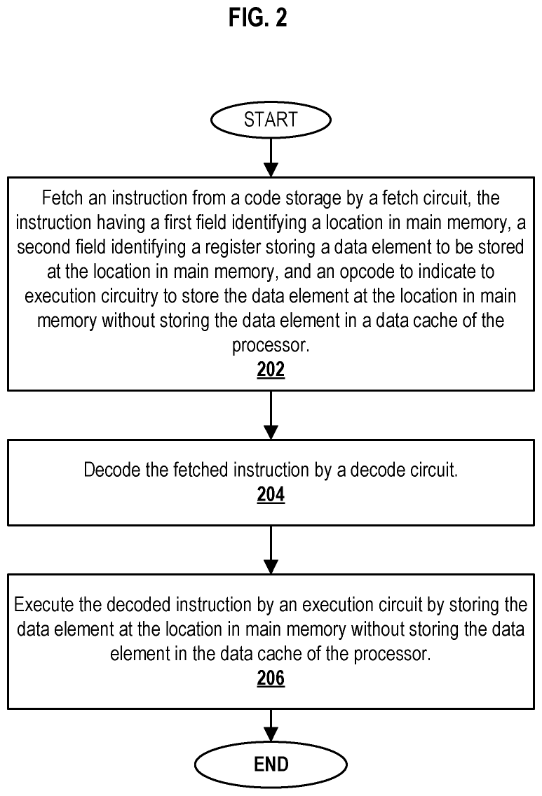

FIG. 2 is a flow diagram illustrating an example method of storing data elements directly to main memory and without using a data cache according to embodiments. Method 300 may be performed by a processor such as processor 100.

At block 202, an instruction is fetched from code storage by a fetch circuit, the instruction having a first field identifying a location in main memory, a second field identifying a register storing a data element to be stored at the location in main memory, and an opcode to indicate to execution circuitry to store the data element at the location in main memory without storing the data element in a data cache of the processor. In one embodiment, second field identifies a plurality of data elements, where a size of each of the plurality of data elements is less than the cache line size of the processor. For example, plurality of data elements may be data elements of an array or a vector. The instruction may be an instruction specifically for storing the plurality of data elements without considering spatial locality of the data elements, such as a STORENS (short for “Store No-Spatial”) and VSCATTERNS (short for “Vector Scatter No-Spatial”).

At block 204, the fetched instruction is decoded by a decode circuit.

At block 206, the decoded instruction is executed by storing the data element at the location in main memory without storing the data element in the data cache of the processor.

In one embodiment, the operations described above involve at least two steps. For example, a plurality of data elements may be scattered to a temporary buffer or a lower level cache (LLC) of the processor. The one or more data element(s) are then stored to main memory from the temporary buffer or LLC of the processor.

Note that the processor is able to perform storing without considering spatial locality in an embodiment. For example, the processor may store one data element by first loading an existing data element at the storage location in main memory along with its spatially adjacent data elements into the L1 cache. In storing a plurality of data elements, a decoded instruction may cause the processor to store the plurality of data elements by first loading the plurality of data elements along with spatially adjacent data elements to the L1 cache. In one embodiment, the difference in storing behavior depends on what instruction is decoded and, according one embodiment of the invention, if the store instruction indicates as such, the storing will cause the processor to store the data element(s) directly to main memory without storing the data element(s) to a data cache.

In an embodiment, a non-temporal scatter instruction is also described. The execution of a non-temporal scatter instruction includes writing data elements to main memory in smaller than cache size granularity. In one example, multiple data elements can be transferred as a single quantity (e.g., a single 512-bit quantity, corresponding to one cache line) all the way to memory at which point the elements are dispatched to respective storage locations.

### Detailed Exemplary Systems, Processors, and Emulation

Detailed herein are examples of hardware, software, etc. to execute the above described instructions. For example, what is described below details aspects of instruction execution including various pipeline stages such as fetch, decode, schedule, execute, retire, etc.

An instruction set includes one or more instruction formats. A given instruction format defines various fields (number of bits, location of bits) to specify, among other things, the operation to be performed (opcode) and the operand(s) on which that operation is to be performed. Some instruction formats are further broken down through the definition of instruction templates (or subformats). For example, the instruction templates of a given instruction format may be defined to have different subsets of the instruction format's fields (the included fields are typically in the same order, but at least some have different bit positions because there are fewer fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2). An occurrence of this ADD instruction in an instruction stream will have specific contents in the operand fields that select specific operands.

### Exemplary Instruction Formats

Embodiments of the instruction(s) described herein may be embodied in different formats. Additionally, exemplary systems, architectures, and pipelines are detailed below. Embodiments of the instruction(s) may be executed on such systems, architectures, and pipelines, but are not limited to those detailed.

### VEX Instruction Format

VEX encoding allows instructions to have more than two operands, and allows SIMD vector registers to be longer than 128 bits. The use of a VEX prefix provides for three-operand (or more) syntax. For example, previous two-operand instructions performed operations such as A=A+B, which overwrites a source operand. The use of a VEX prefix enables operands to perform nondestructive operations such as A=B+C.

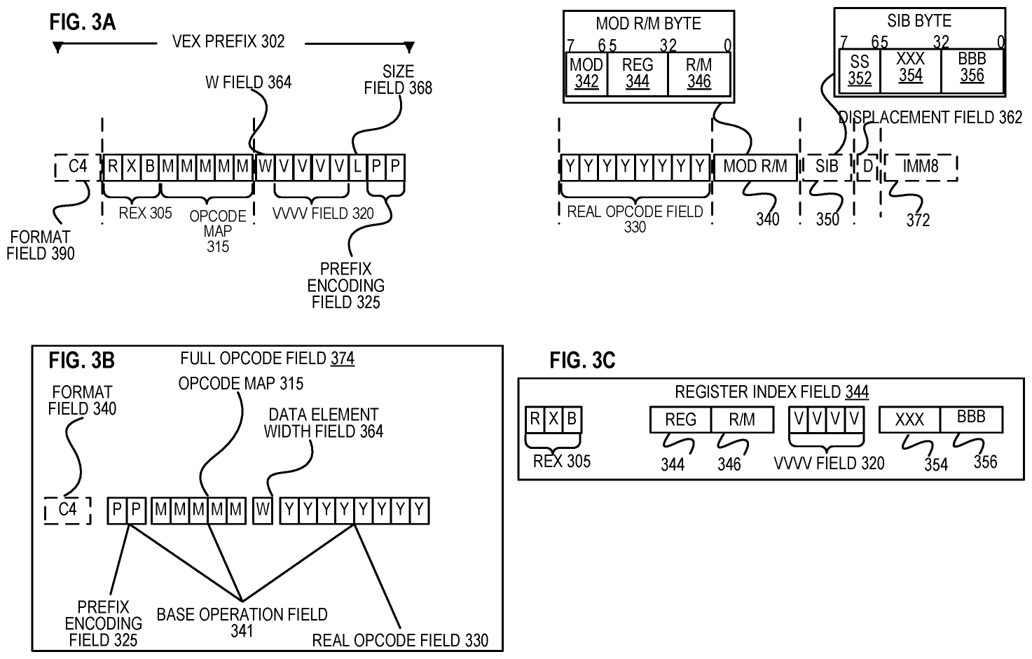

FIG. 3A illustrates an exemplary AVX instruction format including a VEX prefix 302, real opcode field 330, Mod R/M byte 340, SIB byte 350, displacement field 362, and IMM8 372. FIG. 3B illustrates which fields from FIG. 3A make up a full opcode field 374 and a base operation field 341. FIG. 3C illustrates which fields from FIG. 3A make up a register index field 344.

VEX Prefix (Bytes 0-2) 302 is encoded in a three-byte form. The first byte is the Format Field 390 (VEX Byte 0, bits [7:0]), which contains an explicit C4 byte value (the unique value used for distinguishing the C4 instruction format). The second and third bytes (VEX Bytes 1 and 2) include several bit fields providing specific capability. Specifically, REX field 305 (VEX Byte 1, bits [7:5]) consists of a VEX.R bit field (VEX Byte 1, bit [7]-R), VEX.X bit field (VEX byte 1, bit [6]-X), and VEX.B bit field (VEX byte 1, bit[5]-B). Other fields of the instructions encode the lower three bits of the register indexes as is known in the art (rrr, xxx, and bbb), so that Rrrr, Xxxx, and Bbbb may be formed by adding VEX.R, VEX.X, and VEX.B. Opcode map field 315 (VEX byte 1, bits [4:0]-mmmmm) includes content to encode an implied leading opcode byte. W Field 364 (VEX byte 2, bit [7]-W)—is represented by the notation VEX.W and provides different functions depending on the instruction. The role of VEX.vvvv 320 (VEX Byte 2, bits [6:3]-vvvv) may include the following: 1) VEX.vvvv encodes the first source register operand, specified in inverted (ls complement) form and is valid for instructions with 2 or more source operands; 2) VEX.vvvv encodes the destination register operand, specified in is complement form for certain vector shifts; or 3) VEX.vvvv does not encode any operand, the field is reserved and should contain 1111b. If VEX.L 368 Size field (VEX byte 2, bit [2]−L)=0, it indicates 128-bit vector; if VEX.L=1, it indicates 256-bit vector. Prefix encoding field 325 (VEX byte 2, bits [1:0]-pp) provides additional bits for the base operation field 341.

Real Opcode Field 330 (Byte 3) is also known as the opcode byte. Part of the opcode is specified in this field.

MOD R/M Field 340 (Byte 4) includes MOD field 342 (bits [7:6]), Reg field 344 (bits [5:3]), and R/M field 346 (bits [2:0]). The role of Reg field 344 may include the following: encoding either the destination register operand or a source register operand (the rrr of Rrrr), or be treated as an opcode extension and not used to encode any instruction operand. The role of R/M field 346 may include the following: encoding the instruction operand that references a memory address, or encoding either the destination register operand or a source register operand.

Scale, Index, Base (SIB)—The content of Scale field 350 (Byte 5) includes SS 352 (bits [7:6]), which is used for memory address generation. The contents of SIB.xxx 354 (bits [5:3]) and SIB.bbb 356 (bits [2:0]) have been previously referred to with regard to the register indexes Xxxx and Bbbb.

The Displacement Field 362 and the immediate field (IMM8) 372 contain data.

### Exemplary Register Architecture

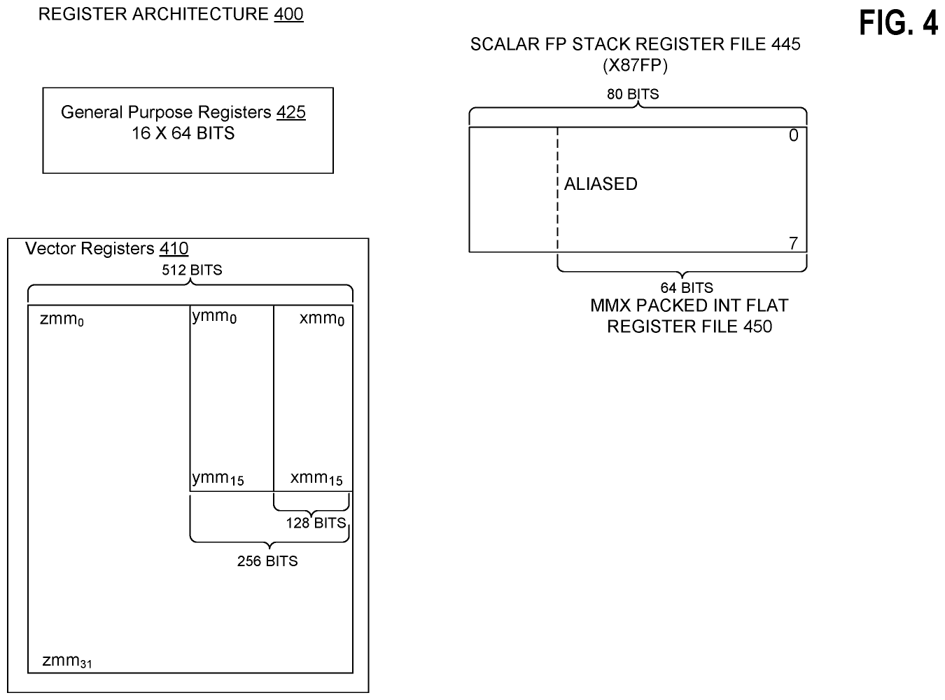

FIG. 4 is a block diagram of a register architecture 400 according to one embodiment of the invention. In the embodiment illustrated, there are 32 vector registers 410 that are each 512 bits wide; these registers are referenced as zmm0 through zmm31. The lower order 256 bits of the lower 410 zmm registers are overlaid on registers ymm0-15. The lower order 128 bits of the lower 410 zmm registers (the lower order 128 bits of the ymm registers) are overlaid on registers xmm0-15.

General-purpose registers 425—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Scalar floating point stack register file (x87 stack) 445, on which is aliased the MMX packed integer flat register file 450—in the embodiment illustrated, the x87 stack is an eight-element stack used to perform scalar floating-point operations on 32/64/80-bit floating point data using the x87 instruction set extension. The MMX registers are used to perform operations on 64-bit packed integer data, as well as to hold operands for some operations performed between the MMX and XMM registers.

Alternative embodiments of the invention may use wider or narrower registers. Additionally, alternative embodiments of the invention may use more, less, or different register files and registers.

### Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures. Detailed herein are circuits (units) that comprise exemplary cores, processors, etc.

### Exemplary Core Architectures

### In-Order and Out-of-Order Core Block Diagram

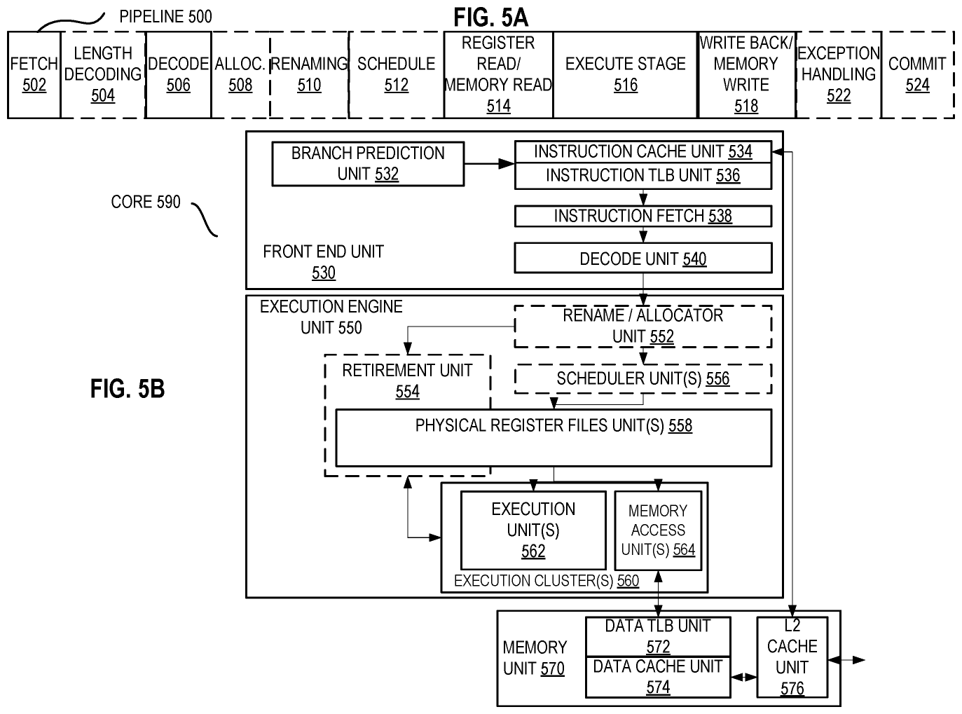

FIG. 5A is a block diagram illustrating both an exemplary in-order pipeline and an exemplary register renaming, out-of-order issue/execution pipeline according to embodiments of the invention. FIG. 5B is a block diagram illustrating both an exemplary embodiment of an in-order architecture core and an exemplary register renaming, out-of-order issue/execution architecture core to be included in a processor according to embodiments of the invention. The solid lined boxes in FIGS. 5A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 5A, a processor pipeline 500 includes a fetch stage 502, a length decode stage 504, a decode stage 506, an allocation stage 508, a renaming stage 510, a scheduling (also known as a dispatch or issue) stage 512, a register read/memory read stage 514, an execute stage 516, a write back/memory write stage 518, an exception handling stage 522, and a commit stage 524.

FIG. 5B shows processor core 590 including a front-end unit 530 coupled to an execution engine unit 550, and both are coupled to a memory unit 570. The core 590 may be a reduced instruction set computing (RISC) core, a complex instruction set computing (CISC) core, a very long instruction word (VLIW) core, or a hybrid or alternative core type. As yet another option, the core 590 may be a special-purpose core, such as, for example, a network or communication core, compression engine, coprocessor core, general purpose computing graphics processing unit (GPGPU) core, graphics core, or the like.

The front-end unit 530 includes a branch prediction unit 532 coupled to an instruction cache unit 534, which is coupled to an instruction translation lookaside buffer (TLB) 536, which is coupled to an instruction fetch unit 538, which is coupled to a decode unit 540. The decode unit 540 (or decoder) may decode instructions, and generate as an output of one or more micro-operations, micro-code entry points, microinstructions, other instructions, or other control signals, which are decoded from, or which otherwise reflect, or are derived from, the original instructions. The decode unit 540 may be implemented using various different mechanisms. Examples of suitable mechanisms include, but are not limited to, look-up tables, hardware implementations, programmable logic arrays (PLAs), microcode read only memories (ROMs), etc. In one embodiment, the core 590 includes a microcode ROM or other medium that stores microcode for certain macroinstructions (e.g., in decode unit 540 or otherwise within the front-end unit 530). The decode unit 540 is coupled to a rename/allocator unit 552 in the execution engine unit 550.

The execution engine unit 550 includes the rename/allocator unit 552 coupled to a retirement unit 554 and a set of one or more scheduler unit(s) 556. The scheduler unit(s) 556 represents any number of different schedulers, including reservations stations, central instruction window, etc. The scheduler unit(s) 556 is coupled to the physical register file(s) unit(s) 558. Each of the physical register file(s) units 558 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 558 comprises a vector registers unit and a scalar registers unit. These register units may provide architectural vector registers, vector mask registers, and general-purpose registers. The physical register file(s) unit(s) 558 is overlapped by the retirement unit 554 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 554 and the physical register file(s) unit(s) 558 are coupled to the execution cluster(s) 560. The execution cluster(s) 560 includes a set of one or more execution units 562 and a set of one or more memory access units 564. The execution units 562 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 556, physical register file(s) unit(s) 558, and execution cluster(s) 560 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 564). It should also be understood that where separate pipelines are used, one or more of these pipelines may be out-of-order issue/execution and the rest in-order.

The set of memory access units 564 is coupled to the memory unit 570, which includes a data TLB unit 572 coupled to a data cache unit 574 coupled to a level 2 (L2) cache unit 576. In one exemplary embodiment, the memory access units 564 may include a load unit, a store address unit, and a store data unit, each of which is coupled to the data TLB unit 572 in the memory unit 570. The instruction cache unit 534 is further coupled to a level 2 (L2) cache unit 576 in the memory unit 570. The L2 cache unit 576 is coupled to one or more other levels of cache and eventually to a main memory.

By way of example, the exemplary register renaming, out-of-order issue/execution core architecture may implement the pipeline 500 as follows: 1) the instruction fetch 538 performs the fetch and length decoding stages 502 and 504; 2) the decode unit 540 performs the decode stage 506; 3) the rename/allocator unit 552 performs the allocation stage 508 and renaming stage 510; 4) the scheduler unit(s) 556 performs the schedule stage 512; 5) the physical register file(s) unit(s) 558 and the memory unit 570 perform the register read/memory read stage 514; the execution cluster 560 perform the execute stage 516; 6) the memory unit 570 and the physical register file(s) unit(s) 558 perform the write back/memory write stage 518; 7) various units may be involved in the exception handling stage 522; and 8) the retirement unit 554 and the physical register file(s) unit(s) 558 perform the commit stage 524.

The core 590 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 590 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 534/574 and a shared L2 cache unit 576, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

### Specific Exemplary In-Order Core Architecture

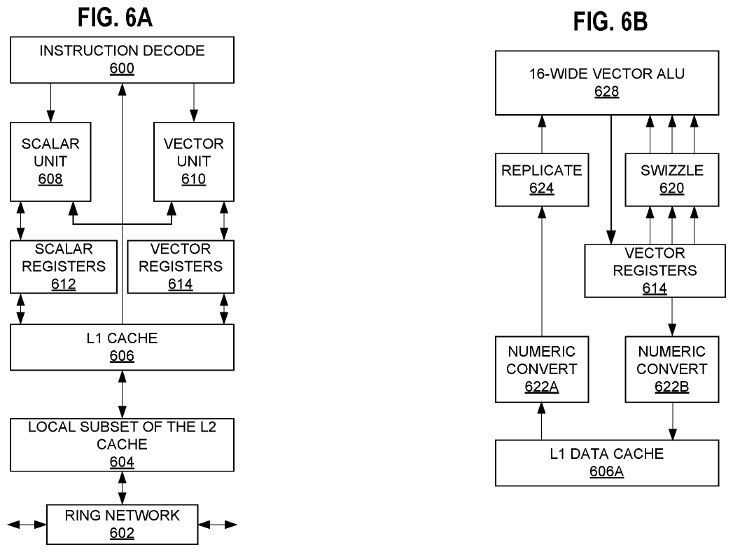

FIGS. 6A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 6A is a block diagram of a single processor core, along with its connection to the on-die interconnect network 602 and with its local subset of the Level 2 (L2) cache 604, according to embodiments of the invention. In one embodiment, an instruction decoder 600 supports the x86 instruction set with a packed data instruction set extension. An L1 cache 606 allows low-latency accesses to cache memory into the scalar and vector units. While in one embodiment (to simplify the design), a scalar unit 608 and a vector unit 610 use separate register sets (respectively, scalar registers 612 and vector registers 614) and data transferred between them is written to memory and then read back in from a level 1 (L1) cache 606, alternative embodiments of the invention may use a different approach (e.g., use a single register set or include a communication path that allow data to be transferred between the two register files without being written and read back).

The local subset of the L2 cache 604 is part of a global L2 cache that is divided into separate local subsets, one per processor core. Each processor core has a direct access path to its own local subset of the L2 cache 604. Data read by a processor core is stored in its L2 cache subset 604 and can be accessed quickly, in parallel with other processor cores accessing their own local L2 cache subsets. Data written by a processor core is stored in its own L2 cache subset 604 and is flushed from other subsets, if necessary. The ring network ensures coherency for shared data. The ring network is bi-directional to allow agents such as processor cores, L2 caches and other logic blocks to communicate with each other within the chip. Each ring data-path is 1024-bits wide per direction in some embodiments.

FIG. 6B is an expanded view of part of the processor core in FIG. 6A according to embodiments of the invention. FIG. 6B includes an L1 data cache 606A part of the L1 cache 604, as well as more detail regarding the vector unit 610 and the vector registers 614. Specifically, the vector unit 610 is a 10-wide vector processing unit (VPU) (see the 16-wide ALU 628), which executes one or more of integer, single-precision float, and double-precision float instructions. The VPU supports swizzling the register inputs with swizzle unit 620, numeric conversion with numeric convert units 622A-B, and replication with replication unit 624 on the memory input.

### Processor with Integrated Memory Controller and Graphics

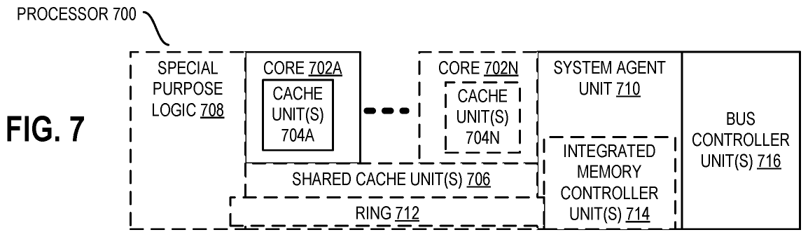

FIG. 7 is a block diagram of a processor 700 that may have more than one core, may have an integrated memory controller, and may have integrated graphics according to embodiments of the invention. The solid lined boxes in FIG. 7 illustrate a processor 700 with a single core 702A, a system agent 710, a set of one or more bus controller units 716, while the optional addition of the dashed lined boxes illustrates an alternative processor 700 with multiple cores 702A-N, a set of one or more integrated memory controller unit(s) 714 in the system agent unit 710, and special purpose logic 708.

Thus, different implementations of the processor 700 may include: 1) a CPU with the special purpose logic 708 being integrated graphics and/or scientific (throughput) logic (which may include one or more cores), and the cores 702A-N being one or more general purpose cores (e.g., general purpose in-order cores, general purpose out-of-order cores, a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 700 may be a part of and/or may be implemented on one or more substrates using any of a number of process technologies, such as, for example, BiCMOS, CMOS, or NMOS.

The memory hierarchy includes one or more levels of cache within the cores 704A-N, a set or one or more shared cache units 706, and external memory (not shown) coupled to the set of integrated memory controller units 714. The set of shared cache units 706 may include one or more mid-level caches, such as level 2 (L2), level 3 (L3), level 4 (L4), or other levels of cache, a last level cache (LLC), and/or combinations thereof While in one embodiment a ring based interconnect unit 712 interconnects the integrated graphics logic 708, the set of shared cache units 706, and the system agent unit 710/integrated memory controller unit(s) 714, alternative embodiments may use any number of well-known techniques for interconnecting such units. In one embodiment, coherency is maintained between one or more cache units 706 and cores 702-A-N.

In some embodiments, one or more of the cores 702A-N are capable of multi-threading. The system agent 710 includes those components coordinating and operating cores 702A-N. The system agent unit 710 may include for example a power control unit (PCU) and a display unit. The PCU may be or include logic and components needed for regulating the power state of the cores 702A-N and the integrated graphics logic 708. The display unit is for driving one or more externally connected displays.

The cores 702A-N may be homogenous or heterogeneous in terms of architecture instruction set; that is, two or more of the cores 702A-N may be capable of execution the same instruction set, while others may be capable of executing only a subset of that instruction set or a different instruction set.

### Exemplary Computer Architectures

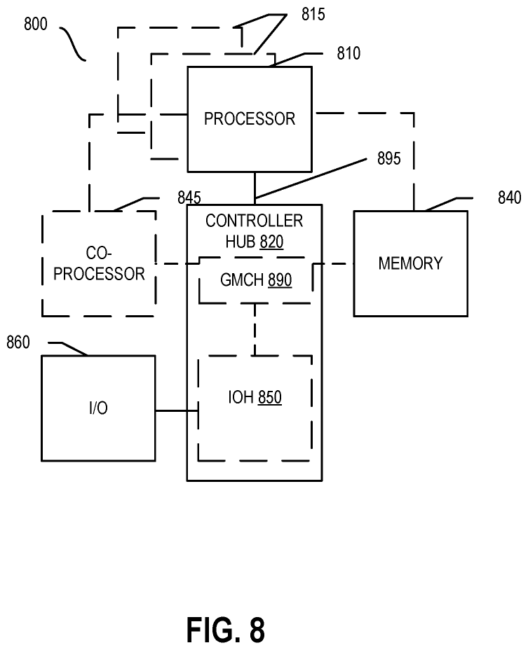

FIGS. 8-12 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 8, shown is a block diagram of a system 800 in accordance with one embodiment of the present invention. The system 800 may include one or more processors 810, 815, which are coupled to a controller hub 820. In one embodiment, the controller hub 820 includes a graphics memory controller hub (GMCH) 890 and an Input/Output Hub (IOH) 850 (which may be on separate chips); the GMCH 890 includes memory and graphics controllers to which are coupled memory 840 and a coprocessor 845; the IOH 850 is couples input/output (I/O) devices 860 to the GMCH 890. Alternatively, one or both of the memory and graphics controllers are integrated within the processor (as described herein), the memory 840 and the coprocessor 845 are coupled directly to the processor 810, and the controller hub 820 in a single chip with the IOH 850.

The optional nature of additional processors 815 is denoted in FIG. 8 with broken lines. Each processor 810, 815 may include one or more of the processing cores described herein and may be some version of the processor 700.

The memory 840 may be, for example, dynamic random access memory (DRAM), phase change memory (PCM), or a combination of the two. For at least one embodiment, the controller hub 820 communicates with the processor(s) 810, 815 via a multi-drop bus, such as a frontside bus (FSB), point-to-point interface, or similar connection 895.

In one embodiment, the coprocessor 845 is a special-purpose processor, such as, for example, a high-throughput MIC processor, a network or communication processor, compression engine, graphics processor, GPGPU, embedded processor, or the like. In one embodiment, controller hub 820 may include an integrated graphics accelerator.

There can be a variety of differences between the physical resources 810, 815 in terms of a spectrum of metrics of merit including architectural, microarchitectural, thermal, power consumption characteristics, and the like.

In one embodiment, the processor 810 executes instructions that control data processing operations of a general type. Embedded within the instructions may be coprocessor instructions. The processor 810 recognizes these coprocessor instructions as being of a type that should be executed by the attached coprocessor 845. Accordingly, the processor 810 issues these coprocessor instructions (or control signals representing coprocessor instructions) on a coprocessor bus or other interconnect, to coprocessor 845. Coprocessor(s) 845 accept and execute the received coprocessor instructions.

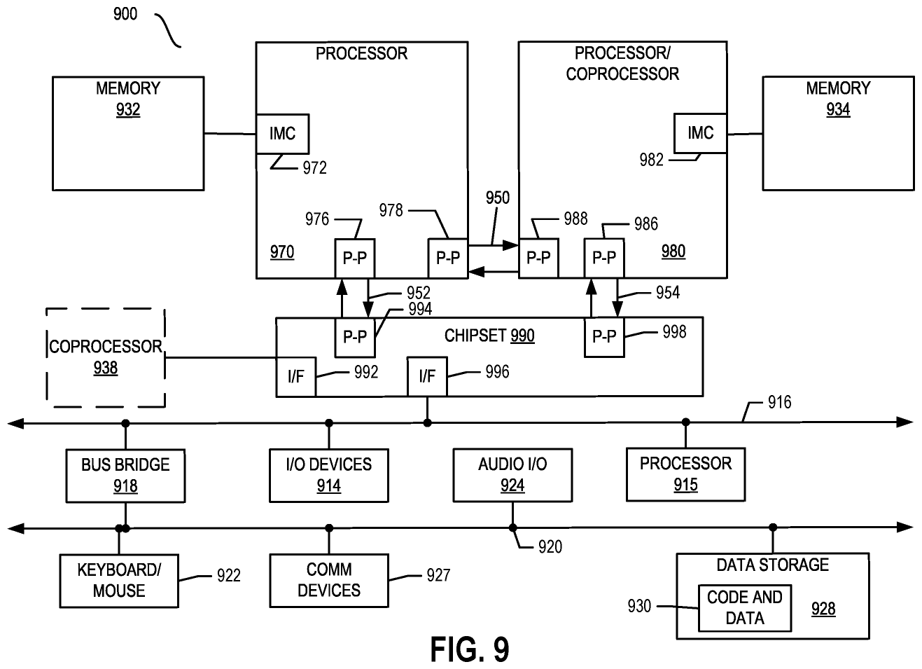

Referring now to FIG. 9, shown is a block diagram of a first more specific exemplary system 900 in accordance with an embodiment of the present invention. As shown in FIG. 9, multiprocessor system 900 is a point-to-point interconnect system, and includes a first processor 970 and a second processor 980 coupled via a point-to-point interconnect 950. Each of processors 970 and 980 may be some version of the processor 700. In one embodiment of the invention, processors 970 and 980 are respectively processors 810 and 815, while coprocessor 938 is coprocessor 845. In another embodiment, processors 970 and 980 are respectively processor 810 coprocessor 845.

Processors 970 and 980 are shown including integrated memory controller (IMC) units 972 and 982, respectively. Processor 970 also includes as part of its bus controller units point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may optionally exchange information with the coprocessor 938 via a high-performance interface 992. In one embodiment, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCI Express bus or another I/O interconnect bus, although the scope of the present invention is not so limited.

As shown in FIG. 9, various I/O devices 914 may be coupled to first bus 916, along with a bus bridge 918 which couples first bus 916 to a second bus 920. In one embodiment, one or more additional processor(s) 915, such as coprocessors, high-throughput MIC processors, GPGPU's, accelerators (such as, e.g., graphics accelerators or digital signal processing (DSP) units), field programmable gate arrays, or any other processor, are coupled to first bus 916. In one embodiment, second bus 920 may be a low pin count (LPC) bus. Various devices may be coupled to a second bus 920 including, for example, a keyboard and/or mouse 922, communication devices 927 and a storage unit 928 such as a disk drive or other mass storage device which may include instructions/code and data 930, in one embodiment. Further, an audio I/O 924 may be coupled to the second bus 920. Note that other architectures are possible. For example, instead of the point-to-point architecture of FIG. 9, a system may implement a multi-drop bus or other such architecture.

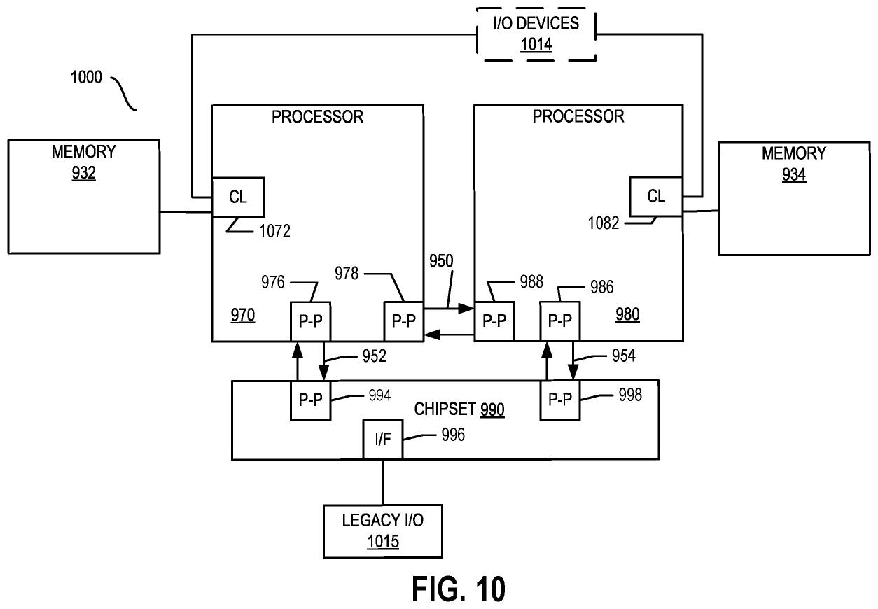

Referring now to FIG. 10, shown is a block diagram of a second more specific exemplary system 1000 in accordance with an embodiment of the present invention. Like elements in FIGS. 9 and 10 bear like reference numerals, and certain aspects of FIG. 9 have been omitted from FIG. 10 in order to avoid obscuring other aspects of FIG. 10.

FIG. 10 illustrates that the processors 970, 980 may include integrated memory and I/O control logic (“CL”) 1072 and 1082, respectively. Thus, the CL 1072, 1082 include integrated memory controller units and include I/O control logic. FIG. 10 illustrates that not only are the memories 932, 934 coupled to the CL 972, 982, but also that I/O devices 1014 are also coupled to the control logic 972, 982. Legacy I/O devices 1015 are coupled to the chipset 990.

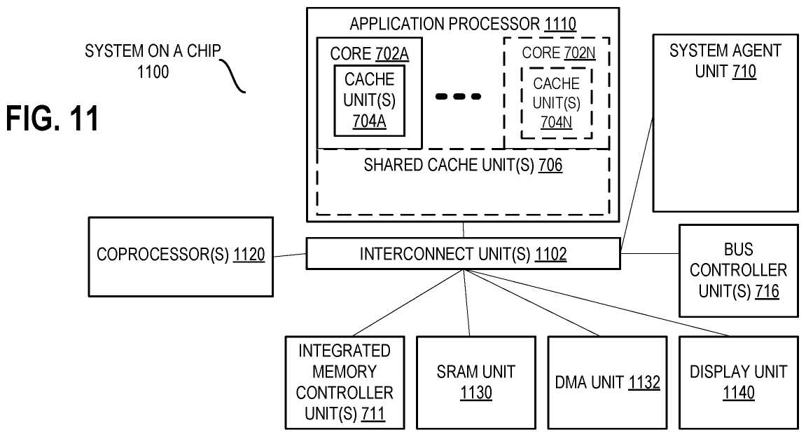

Referring now to FIG. 11, shown is a block diagram of a SoC 1100 in accordance with an embodiment of the present invention. Similar elements in FIG. 7 bear like reference numerals. Also, dashed lined boxes are optional features on more advanced SoCs. In FIG. 11, an interconnect unit(s) 1102 is coupled to: an application processor 910 which includes a set of one or more cores 702A-N, cache units 704A-N, and shared cache unit(s) 706; a system agent unit 710; a bus controller unit(s) 716; an integrated memory controller unit(s) 714; a set or one or more coprocessors 1120 which may include integrated graphics logic, an image processor, an audio processor, and a video processor; an static random access memory (SRAM) unit 1130; a direct memory access (DMA) unit 1132; and a display unit 1140 for coupling to one or more external displays. In one embodiment, the coprocessor(s) 1120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 930 illustrated in FIG. 9, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

### Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

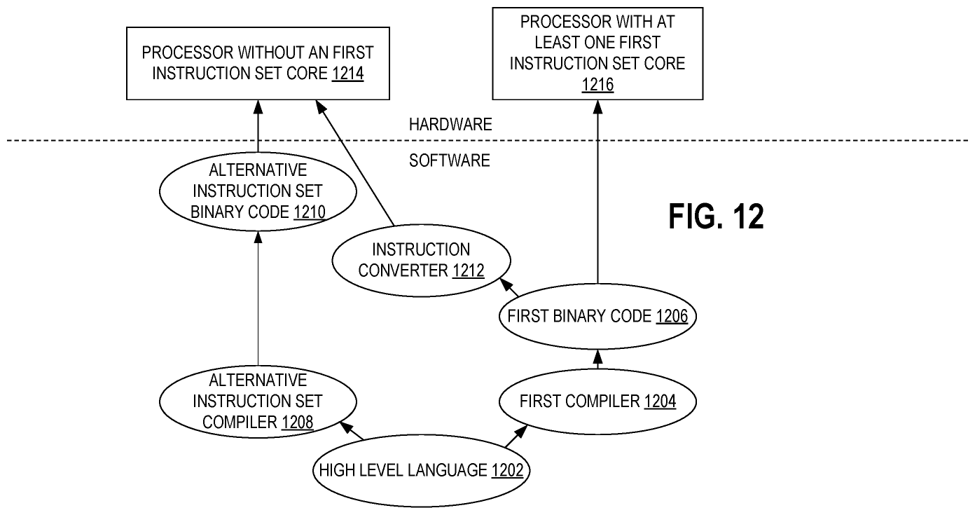

FIG. 12 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 12 shows a program in a high level language 1202 may be compiled using an first compiler 1204 to generate a first binary code (e.g., x86) 1206 that may be natively executed by a processor with at least one first instruction set core 1216. In some embodiments, the processor with at least one first instruction set core 1216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The first compiler 1204 represents a compiler that is operable to generate binary code of the first instruction set 1206 (e.g., object code) that can, with or without additional linkage processing, be executed on the processor with at least one first instruction set core 1216. Similarly, FIG. 12 shows the program in the high level language 1202 may be compiled using an alternative instruction set compiler 1208 to generate alternative instruction set binary code 1210 that may be natively executed by a processor without at least one first instruction set core 1214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1212 is used to convert the first binary code 1206 into code that may be natively executed by the processor without a first instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have a first instruction set processor or core to execute the first binary code 1206.

### FURTHER EXAMPLES

Example 1 provides a method, comprising: decoding an instruction by a decode circuit, the instruction having a first field identifying a location in main memory, a second field identifying a register storing a data element to be stored at the location in main memory, and an opcode to indicate to execution circuitry to store the data element at the location in main memory without storing the data element in a data cache of a processor; and executing the decoded instruction by an execution circuit by storing the data element at the location in main memory without storing the data element in the data cache of the processor.

Example 2 includes the substance of the exemplary method of Example 1, where the storing of the data element includes: storing the data element in a temporary buffer; and storing the data element from the temporary buffer to the location in main memory.

Example 3 includes the substance of the exemplary method of Example 1, where the storing of the data element includes: storing the data element in a lower level cache of the processor; and storing the data element from the lower level cache to the location in main memory.

Example 4 includes the substance of the exemplary method of Example 1, wherein the instruction indicates that the data element is to be stored without considering spatial locality.

Example 5 includes the substance of the exemplary method of Example 4, wherein the instruction specifies an index corresponding to locations of each of a plurality of data elements, and wherein the instruction specifies a stride value between data elements of the plurality of data elements.

Example 6 includes the substance of the exemplary method of Example 5, the stride value is bigger than a cache line size of the processor.

Example 7 includes the substance of the exemplary method of Example 4, wherein the instruction specifies an index corresponding to locations of each of a plurality of data elements, and wherein the storing includes storing the plurality of data elements at a plurality of storage locations in main memory without storing the plurality of data elements in the data cache of the processor.

Example 8 provides a processor, comprising: a decoder to decode an instruction having a first field identifying a location in main memory, a second field identifying a register storing a data element to be stored at the location in main memory, and an opcode to indicate to execution circuitry to store the data element at the location in main memory without storing the data element in the data cache of the processor; and execution circuitry to execute the decoded instruction to store the data element at the location in main memory without storing the data element in the data cache of the processor.

Example 9 includes the substance of the exemplary processor of Example 8, wherein to store the data element includes to: store the data element in a temporary buffer; and store the data element from the temporary buffer to the location in main memory.

Example 10 includes the substance of the exemplary processor of Example 8, wherein to store the data element includes to: store the data element in a lower level cache of the processor; and store the data element from the lower level cache to the location in main memory.

Example 11 includes the substance of the exemplary processor of Example 8, wherein the instruction is to indicate the data element is to be stored without considering spatial locality.

Example 12 includes the substance of the exemplary processor of Example 8, wherein the instruction is to specify an index corresponding to locations of each of a plurality of data elements, and wherein the instruction specifies a stride value between data elements of the plurality of data elements.

Example 13 includes the substance of the exemplary processor of Example 12, wherein the stride value is bigger than a cache line size of the processor.

Example 14 includes the substance of the exemplary processor of Example 11, wherein the instruction is to specify an index corresponding to locations of each of a plurality of data elements, and wherein to store is to include to store the plurality of data elements at a plurality of storage locations in main memory without storing the plurality of data elements in the data cache of the processor.

Example 15 provides a computer system, comprising: a memory for storing instructions; a processor including: a data cache; a decoder unit to decode an instruction, the instruction having a first field identifying a location in main memory, a second field identifying a register storing a data element to be stored at the location in main memory, and an opcode to indicate to execution circuitry to store the data element at the location in main memory without storing the data element in a data cache of the processor; and an execution unit to store the data element at the location in main memory without storing the data element in the data cache of the processor.

Example 16 includes the substance of the exemplary computer system of Example 15, where to store the data element includes to: store the data element in a temporary buffer; and store the data element from the temporary buffer to the location in main memory.

Example 17 includes the substance of the exemplary computer system of Example 15, where to store the data element includes: to store the data element in a lower level cache of the computer system; and to store the data element from the lower level cache to the location in main memory.

Example 18 includes the substance of the exemplary computer system of Example 15, wherein the instruction indicates that the data element is to be stored without considering spatial locality.

Example 19 includes the substance of the exemplary computer system of Example 18, wherein the instruction specifies an index corresponding to locations of each of a plurality of data elements, and wherein the instruction specifies a stride value between data elements of the plurality of data elements.

Example 20 includes the substance of the exemplary computer system of Example 19, wherein the stride value is bigger than a cache line size of the computer system.

What is claimed is:

1. A method, comprising:
decoding an instruction by a decode circuit, the instruction having a first field identifying a location in main memory, a second field identifying a register storing a data element to be stored at the location in main memory, and an opcode to indicate to execution circuitry to store the data element at the location in main memory without storing the data element in a data cache of a processor; and
executing the decoded instruction by an execution circuit by storing the data element at the location in main memory without storing the data element in the data cache of the processor.

2. The method of claim 1, where the storing of the data element includes:
storing the data element in a temporary buffer; and
storing the data element from the temporary buffer to the location in main memory.

3. The method of claim 1, where the storing of the data element includes:
storing the data element in a lower level cache of the processor; and
storing the data element from the lower level cache to the location in main memory.

4. The method of claim 1, wherein the instruction indicates that the data element is to be stored without considering spatial locality.

5. The method of claim 4, wherein the instruction specifies an index corresponding to locations of each of a plurality of data elements, and wherein the instruction specifies a stride value between data elements of the plurality of data elements.

6. The method of claim 5, the stride value is bigger than a cache line size of the processor.

7. The method of claim 4, wherein the instruction specifies an index corresponding to locations of each of a plurality of data elements, and wherein the storing includes storing the plurality of data elements at a plurality of storage locations in main memory without storing the plurality of data elements in the data cache of the processor.

8. A processor, comprising:
a decoder to decode an instruction having a first field identifying a location in main memory, a second field identifying a register storing a data element to be stored at the location in main memory, and an opcode to indicate to execution circuitry to store the data element at the location in main memory without storing the data element in the data cache of the processor; and
execution circuitry to execute the decoded instruction to store the data element at the location in main memory without storing the data element in the data cache of the processor.

9. The processor of claim 8, wherein to store the data element includes to:
store the data element in a temporary buffer; and
store the data element from the temporary buffer to the location in main memory.

10. The processor of claim 8, wherein to store the data element includes to:
store the data element in a lower level cache of the processor; and
store the data element from the lower level cache to the location in main memory.

11. The processor of claim 8, wherein the instruction is to indicate the data element is to be stored without considering spatial locality.

12. The processor of claim 11, wherein the instruction is to specify an index corresponding to locations of each of a plurality of data elements, and wherein the instruction specifies a stride value between data elements of the plurality of data elements.

13. The processor of claim 12, wherein the stride value is bigger than a cache line size of the processor.

14. The processor of claim 11, wherein the instruction is to specify an index corresponding to locations of each of a plurality of data elements, and wherein to store is to include to store the plurality of data elements at a plurality of storage locations in main memory without storing the plurality of data elements in the data cache of the processor.

15. A computer system, comprising:
a memory for storing instructions;
a processor including:
a data cache;
a decoder unit to decode an instruction, the instruction having a first field identifying a location in main memory, a second field identifying a register storing a data element to be stored at the location in main memory, and an opcode to indicate to execution circuitry to store the data element at the location in main memory without storing the data element in a data cache of the processor; and
an execution unit to store the data element at the location in main memory without storing the data element in the data cache of the processor.

16. The computer system of claim 15, where to store the data element includes to:
store the data element in a temporary buffer; and
store the data element from the temporary buffer to the location in main memory.

17. The computer system of claim 15, where to store the data element includes:
to store the data element in a lower level cache of the computer system; and
to store the data element from the lower level cache to the location in main memory.

18. The computer system of claim 15, wherein the instruction indicates that the data element is to be stored without considering spatial locality.

19. The computer system of claim 18, wherein the instruction specifies an index corresponding to locations of each of a plurality of data elements, and wherein the instruction specifies a stride value between data elements of the plurality of data elements.

20. The computer system of claim 19, wherein the stride value is bigger than a cache line size of the computer system.
